(19) United States
(12) Patent Application Publication
(10) Pub. No.: US 2021/0022377 A1
(43) Pub. Date: Jan. 28, 2021

(54) SEASONED FOOD PRODUCT AND METHOD

(71) Applicant: POTANDON PRODUCE, LLC, Idaho Falls, ID (US)

(72) Inventor: Dennis Lonergan, Long Lake, MN (US)

(21) Appl. No.: 17/071,222

(22) Filed: Oct. 15, 2020

Related U.S. Application Data
(63) Continuation-in-part of application No. 15/606,559, filed on May 26, 2017.
(60) Provisional application No. 62/342,407, filed on May 27, 2016.

(51) Int. Cl. A23L 19/12; A23L 5/10; A23L 19/00; A23L 33/115; A23L 5/30

(52) U.S. Cl. CPC A23L 19/12; A23L 5/15; A23L 5/34; A23L 33/115; A23L 19/03

(57) ABSTRACT

A packaged food product with a seasoning disk is provided. The food product includes potatoes. The seasoning disk includes seasoning and fat that is in solid form at the food product's anticipated normal storage temperature. The fat includes milkfat. The potatoes can also be cooked and mashed in the package and can include a seasoning disk.

### CROSS REFERENCE TO RELATED APPLICATIONS

In accordance with 37 C.F.R 1.76, a claim of priority is included in an Application Data Sheet filed concurrently herewith. Accordingly, the present invention is a Continuation-In-Part of U.S. Non-Provisional patent application Ser. No. 15/606,559 entitled “SEASONED FOOD PRODUCT AND METHOD” filed May 26, 2017, which claims priority under 35 U.S.C. § 119(e) to U.S. Provisional Application 62/342,407 entitled “SEASONED FOOD PRODUCT AND METHOD” filed on May 27, 2016. The contents of the above referenced application are herein incorporated by reference in its entirety.

### FIELD OF THE INVENTION

The present invention relates to a packaged tuber food product that contains a fat based seasoning disk in a first embodiment that is stable during shipment and storage of the product. In a second embodiment, it can contain a fat based seasoning disk. When the food product and disk are heated for cooking the food product, the fat liquefies, allowing the fat and seasoning contained within the disk to coat at least a portion of the tubers; and in the second embodiment, be mixed with the potatoes during mashing.

### BACKGROUND OF THE INVENTION

An important aspect of food for human consumption is to have it convenient for preparation. Another important aspect of food is to provide seasoning for the food to enhance its organoleptic properties for consumption. It is known in the art to provide packaged food products with seasoning sold with the food product, typically in packets, for application to the food just prior to consumption. The seasoning in the packets has typically been in dry form. However, the adhesion of the seasoning to the food may not be adequate to maintain the seasoning in contact with the food, wherein the effectiveness of the seasoning is reduced or additional seasoning needs to be provided to obtain the desired level of seasoning impact.

It is also desirable to have food products that are shelf stable. Storage of food at refrigerated temperatures is both costly and inconvenient. The requirement for refrigerated storage limits how and where a product can be displayed for sale. Fresh whole potatoes can be displayed on non refrigerated counters and can be stored in the storeroom in the back of the store outside of expensive refrigerators. They can also be displayed in a non produce section of a store if shelf stable. Additional problems with typical potatoes is the time required to cook them, even in a microwave oven, and they are not uniform in weight and must be weighed individually for sale because they are sold by the pound, leaving a consumer in doubt as to cost and quantity. When packaged, fresh potatoes are often stored in ventilated polymeric bags to allow for oxygen migration to reduce the risk of the inside of the bag becoming anaerobic, spoiling the product. Ventilated bags, though, limit the ability of particulates like herbs and spices being provided in the bags. Ventilated bags also allow moisture migration that can damage some herbs and spices. Fresh potatoes also need to “breathe” air for oxygen exchange for extended shelf life.

In a second embodiment, the potatoes are cooked in their storage package and then mashed in the package providing a means for easily adjusting the peel to flesh ratio and provide a convenient way to provide peel on mashed potatoes.

### SUMMARY OF THE INVENTION

The present invention in a first embodiment involves the provision of a packaged food product that is to be heated prior to consumption as, for example, in a microwave oven. The food product is provided with a solid disk containing fat and seasoning that, when heated, the fat liquefies, allowing the seasoning contained therein to be distributed on the food product.

Accordingly, it is a primary objective of the instant invention to provide a packaged food product that allows distribution of seasoning onto the food product after heating of the food product.

It is a further objective of the instant invention to provide a seasoning component that is encapsulated in a solid fat disk during storage of the packaged food product.

It is yet another objective of the instant invention to provide a food product wherein the packaged food product is stored at an ambient temperature of less than about 80° F.

In a second embodiment, the invention provides a way to store potatoes in a package that can be used additionally for cooking the contained potatoes and then for containing the potatoes for mashing and provide a fat disk, if desired, for inclusion in the final mashed potatoes with peel on.

Other objects and advantages of this invention will become apparent from the following description taken in conjunction with any accompanying drawings wherein are set forth, by way of illustration and example, certain embodiments of this invention. Any drawings contained herein constitute a part of this specification, include exemplary embodiments of the present invention, and illustrate various objects and features thereof.

### BRIEF DESCRIPTION OF THE FIGURES

FIG. 1 is a side elevation view of the packaged food product having a solid form seasoning disk.

FIG. 2 is a perspective view of an alternate package for the food product; and

FIG. 3 is a perspective view of a second embodiment of a package of food product for producing mashed potatoes.

### DETAILED DESCRIPTION OF THE INVENTION

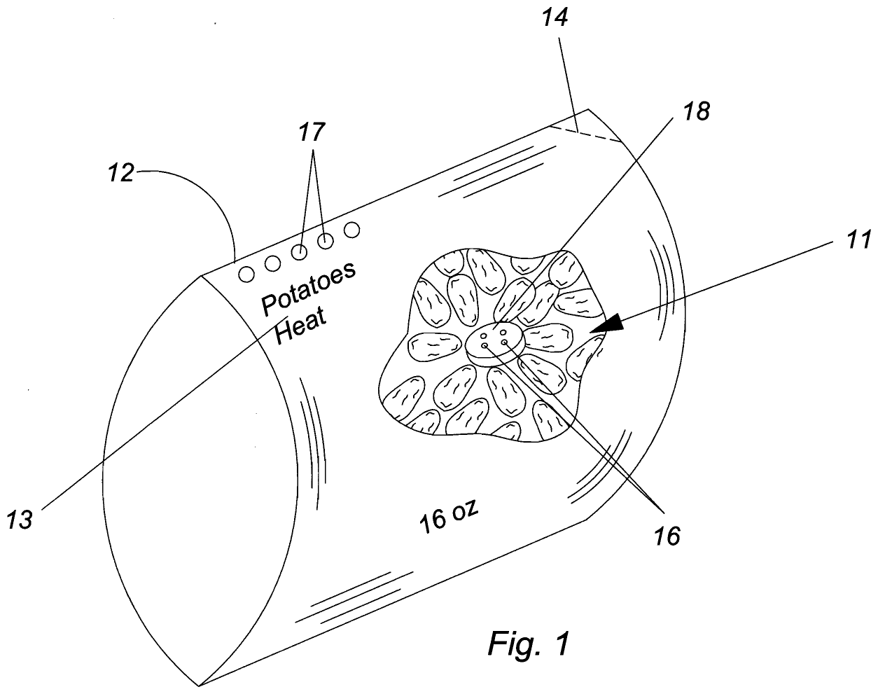

FIG. 1 illustrates a food product designated generally 11 contained in a package designated generally 12. The food product 11 is a plurality of whole potatoes with peel. For purposes of this application, a potato is a starchy tuberous crop from the perennial nightshade family having a botanical name Solanum tuberosum L. Further, a potato is the tuberous portion of the plant. In a preferred embodiment, the food product 11 is a plurality of small whole unpeeled fresh potatoes as, for example, sized to provide about 10-35 potatoes per pound. A preferred quantity of food product 11 in a package 12 is in the range of between about 0.5 pounds and about 2 pounds and, more preferably, on the order of about 1 pound.

The package 12 can be any suitable package adapted for storage of the food product 11 and heating of the food product and seasoning disk 15 therein. The package 12 is substantially closed and has a storage chamber 16. This can be in the form of a clear polymeric material with or without means 14, such as a perforated line, to effect opening thereof without a tool, such as a knife or scissors. Such packages are well known in the art and may be made from polyethylene, polypropylene or other food acceptable material. The package 12 can be an internal package, and can be contained in an outer package 14. The package 12, or an outer package 14, can contain suitable graphics, branding, labeling information and preparation instructions 13 as are also well known in the art. The package 12 is ventilated to allow air/oxygen to transfer from the outer environment to the inside of the package. This can be accomplished by using a perforated material to form the package 12, for example, perforations 17 on the order of 0.002 square inches or smaller (0.050 inch diameter holes or smaller equivalent). What is meant by “substantially closed” is that the package is ventilated as described, but will retain generated steam to expand the package. The package may also be made from an oxygen permeable material as is known in the art. The permeability is adequate to preclude the ingress to the package interior of detrimental solids.

Contained within the package 12 is the seasoning disk 15. The disk 15 can be any suitable shape and size, with the particulars of a disk and its components being disclosed below. The disk 15 has two major components, a seasoning component designated generally 16 and a carrier component designated generally 18. The seasoning 16 can include such things as spices and herbs, for example parsley, oregano, basil, rosemary, thyme, and savory dried vegetables such as red, green and yellow peppers, onion and garlic, and salt and ground black pepper. Natural and artificial flavors can also be included with the other seasoning components. The spices and or herbs and other seasoning components are preferably dry (typically less than about 10% by weight water) and in particulate form. The seasoning 16 is mixed into the carrier 18 and is preferably present in an amount in the range of between about 1 gram and about 5 grams per pound of food product 11. The ratio of seasoning to carrier is in the range of between about 25:75 percent by weight and about 75:25 percent by weight, and preferably about 50:50 percent by weight. Surprisingly, it has been observed that inclusion of particulate matter (e.g., the spices and/or herbs), beneficially increases the physical rigidity of the seasoning disk 15, as compared to a disk which was composed solely of the fat.

The carrier 18 includes a fat component that has a substantial amount of fat, which allows it to form a disk 15 containing the seasoning 16 that physically is in solid form at 80° F. (26.6° C.) and cooler. Being in solid form does not preclude some of the fat in the disk from being liquid. Preferably, the carrier is at least about 99% by weight fat. The fat component of the disk 15 is substantially water free and is a continuous phase of the disk 15. In a preferred embodiment, the fat is an anhydrous fat containing at least about 99% by weight fat, and preferably at least about 99.5% fat. The fat component contains less than about 1% by weight water by weight of fat plus water. The fat is also crystalline. For flavor purposes, a preferred fat is milkfat, known commonly as butter. At least 50% by weight of the fat is milkfat; preferably at least about 95% by weight of the fat is milkfat, and most preferably substantially all milkfat. Anhydrous butter, by Codex definition, contains at least 99.8% by weight milkfat and is derived from fresh cream or butter. By some definitions, anhydrous butter is not allowed to have additives, but is not so limited with the present invention. Butter can be made in a manner with alkali to neutralize free fatty acids. Typically, butters are made from cow's milk, but can be derived from other animal's milk. The weight of the disk 15 or plurality of disks in a package 12 is preferably in the range of between about 1 gram and about 10 grams per pound of product 11. The fat component preferably has a solids fat index (SFI) (%) of about at: 10.0° C. 33.0-21.1° C. 14.0-26.7° C. 10.0-33.3° C. 3.0-40.0° C. 0 as measured by Nuclear Magnetic Resonance or dilatometry, both well known in the art. It is to be understood that a plurality of disks 15 may be used if desired.

The seasoning disk 15 with fat and seasoning has a water activity (A_{w}) of less than 0.5, well below that of regular butter, which is about 0.95. Disks 15 of the present invention with the seasoning included have A_{w} in the range of between about 0.22 and about 0.36 when measured at 25° C. Water activity, or A_{w}, is the partial vapor pressure of water in a substance divided by the standard state partial vapor pressure of water. In the field of food science, the standard state is most often defined as the partial vapor pressure of pure water at the same temperature. The A_{w} of the disk 15 will differ depending on the ingredients added to the fat component of the carrier 18.

The packaged food product 11 is stored at a temperature of less than about 80° F., and can be stored refrigerated if desired. Refrigerated storage for produce is typically between about 40° F. and about 50° F. In use, the packaged food product 11 is removed from storage and can be immediately heated or allowed to warm, for example, come to room temperature, prior to heating. Preparation instructions can be provided on the package 12 regarding representative cooking times to effect cooking of the food product 11. Preferably, the heating/cooking is done in a microwave oven. A portion of the steam is retained in the storage chamber 16 or 53 during heating of the disk 15 and food product 11. However, venting of the package 12 is desired to prevent excessive pressure buildup in the package during product heating. Venting can be provided by package perforations 17 or by piercing or cutting the package 12 prior to heating.

As seen in the Figures, the seasoning disk 15 can be placed on the top of the food product 11. Its size resists it from moving into the food product 11 during storage. Surprisingly, during heating of the food product 11, the disk 15 disperses and does not require later mixing. However, turning the package over after heating can be done by the consumer to help distribute the disk components. While not being bound by this theory, it is believed that the steam generated from the food product during heating thereof effects dispersion of the melted disk onto the plurality of individual food pieces. Hot water does not effect such dispersion.

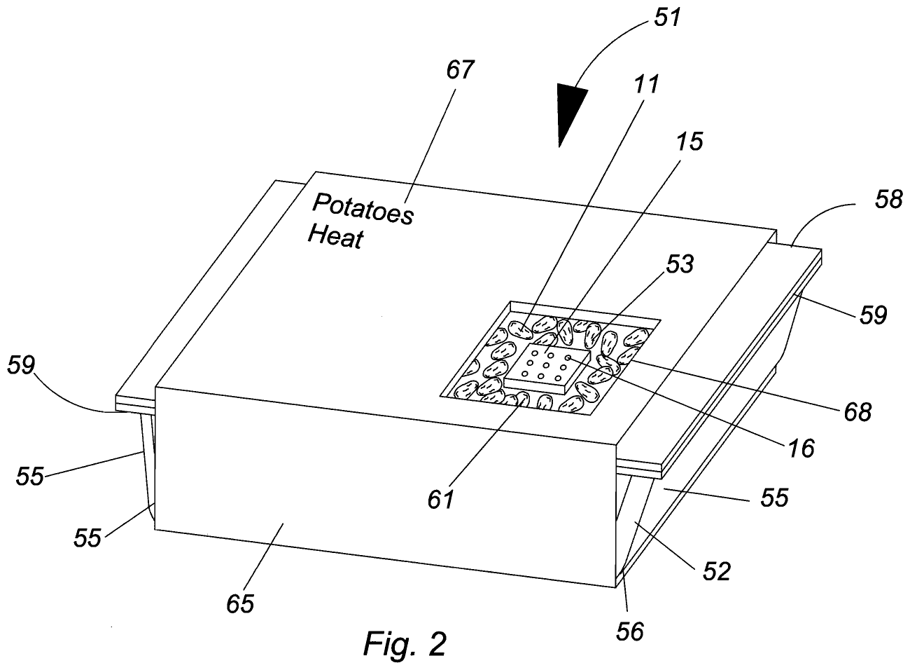

FIG. 2 shows an alternate food package 51 that is also substantially closed. It includes a tray 52 having a storage chamber 53 defined by a plurality of connected sidewalls 55 and a connected bottom wall 56. A cover 58, such as a clear film, is secured to a flange 59 extending from the sidewalls 55 at an open top 61 to the chamber 53. The securement can be by heat sealing, which can be accomplished to allow the cover 58 to be separated from the tray 52 by peeling off. The tray 52 and/or cover 58 can be permeable as described above. The seasoning disk 15 can be positioned on top of individual food pieces comprising the food product 11. A sleeve 65 can be provided for containing the filled and sealed tray 52. Graphics and instructions 67 can be provided on the exterior of the sleeve 65. The sleeve 65 can also be provided with a cut out window 68 for viewing of the product through transparent film of the cover 58. It is to be understood that the disk 15 can be in a separate part of the package 12, separated from the food product 11 if desired. It can be added to the package area containing the food product 11 by the consumer, or can be separated from the food product by a barrier that allows the disk 15 to contact the food product 11 when the barrier is heated during the cooking process.

In use, the package 12 or 51 containing the food product 11 is stored at the appropriate temperature and is shelf stable. For consumption, the package 12 with the contained food product 11 and seasoning disk 15 is placed in the heating device, for example a microwave oven, with the disk 15 on top of the food product 11, and heated for the desired time effective to generate steam to fill the package 12. After the desired amount of heating/cooking, the package 12 can be shaken to effect additional distribution of the carrier 18 and seasoning 16 on the food product 11 if needed. After this, the package 12 can be opened and the food product 11 removed and consumed. It has been found that a cook time of about 5 minutes is effective for 1 pound of potatoes in a 1000 watt oven.

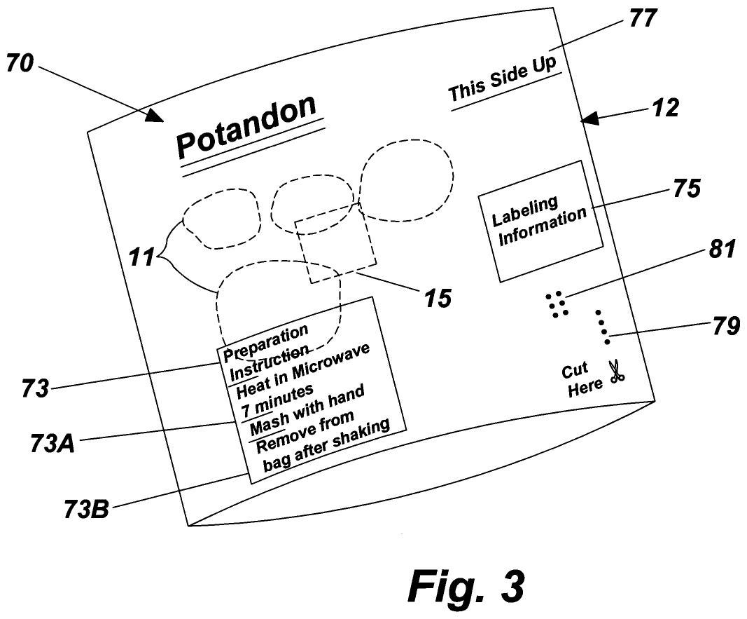

A second embodiment of the present invention is described below and is illustrated in FIG. 3. The second embodiment, like the first embodiment described above, also provides a shelf stable product that is to be sold in retail outlets and is to be cooked by exposure to microwave energy in a microwave oven by a consumer. It preferably involves the use of one or more disks 15 having properties as described above, except for total weight as noted below. For convenience, the at least one disk will be referred to hereinafter as a disk, but the term includes both a single disk or a plurality unless otherwise noted. Preferably, the disk 15 also includes seasoning 16 as described above. A plurality of whole, unpeeled and fresh potatoes comprise the food product, hereinafter referred to for convenience as potatoes, and are contained in a substantially sealed package 12 as described above. While the preferred package is the package 12, it is to be understood that a package 51 could also be utilized. Also, an outer package 14 could also be utilized. For convenience, hereinafter the package will be described as the package 12, and unless otherwise noted, the description applies to both packages.

Any variety or combinations of varieties of potatoes 11 can be used, with Valery, Cecile, Rosara, Isabellia, Noelle and Agata being preferred varieties. The quantity of potatoes 11 in the package has a total weight in the range of between about 0.5 pounds and about 2 pounds, and preferably on the order of about 1 pound. The potatoes 11 comprise about 4 to about 35 potatoes per pound of potatoes, and preferably between about 6 and about 30 potatoes per pound of potatoes. By having a size distribution available, the ratio of peel weight to flesh weight can be easily adjusted to accommodate consumer preference. The at least one disk 15 or the plurality of disks has a weight in the range of between about 10 grams and about 30 grams per pound of potatoes, which amount can exceed that described above for the first embodiment.

The package 12 is substantially closed with a storage chamber 19 with enough perforations 81 (only a few are illustrated) to allow the potatoes 11 to respire during storage and allow the slow exchange of air and moisture with the surrounding atmosphere, and are sufficiently vented to relieve pressure in the chamber 19 to reduce the risk of its rupture during microwave heating. The perforations can be formed by various methods, some known in the art and some proprietary to a producer. One method is a hot needle and another is by “cool” needle. Perforation size may vary across a package depending on the method used. It is estimated that the size of the perforations can be on the order of about 0.2 mm in diameter. The disk 15 can be contained in a separate packet or be contained in the package 12 with the potatoes 11 as described above. In a preferred embodiment, the disk 15 is in solid form for storage and, after melting during microwave heating, comes into in contact with the potatoes during or after the cooking process, so long as the contact is before mashing is completed. It has been found that the packaging material, preferably a polymer or blend of polymers, such as polyethylene and/or polypropylene can be used. It can initially have an opening for placing the potatoes 11 and disk 15 in the chamber 19, and have a portion that will be secured to form a seam to close the opening as known in the art, for example, heat sealing.

When perforations are used for respiration, it is preferred that they be no larger than what is needed for respiration and retaining steam during cooking, which steam also effects expansion of the package 12 during microwave heating. It has been surprisingly found that with perforations 81 of small enough size, the fat in the disk 15 has very low leakage out of the package 12 during microwave cooking of the potatoes 11. Location of the perforations 81 can also be used to reduce the risk of fat leakage, for example, having the perforations positioned on the package side that is the recommended “up side” for cooking.

The package 12 is provided with indicium denoted generally as 70. The indicium 70 will include preparation instructions 73 and can include labeling information 75 as prescribed by law, branding, marketing information and/or graphics, etc. One preferred indicium 77 will include instruction language and/or a pictorial illustration regarding which side of the package should be up (on top) during cooking of the potatoes 11. The exact wording of such instructions and information can vary. For example, which side is to be up during cooking can be indicated by “This side up” on one side and/or “This side down” on the opposite side since they are equivalent statements. Another indicium 79 can include language and/or a pictorial illustration of a preferred location and/or method for opening the package after cooking has been effected. An additional indicium 73 will include language and/or a pictorial illustration providing preparation instructions including at least microwave cooking instructions 73A and potato mashing instructions 73B.

Preparation instructions 73 will include a recommended time range or ranges for cooking time 73A. Preparation instructions will also include mashing instructions 73B and, preferably, manipulation instructions for effecting mixing of the melted disk 15 with the potatoes 11 during mashing. It has been found that mashing can be easily accomplished with the potatoes 11 in the package 12 and that, surprisingly, the mashed potatoes easily release from the package 12 with almost no residual potato material (flesh and peel) being retained in the package. Mashing breaks the peel and breaks the cohesive structure of the cooked flesh. Mashing in the package eliminates the need to dirty a dish or other device. Mashing can be accomplished with a person's hand, like the heel of the palm or the fingers in a fist, or knuckles. It is preferred that, if the hand is used, an insulating member such as a towel or pot holder be used as a thermal insulator. A tool, such as a potato masher (well known in the art, not shown) can also be used to break up the cooked potatoes. The desired degree of mashing, (potato break up) can be easily determined by the user. The invention provides a mashed potato product with “skin-on” (peel-on) with fat from the disc 15 and flavoring, if provided with the fat of the disk as described, in a very convenient form. While the preferred mashing process utilizes the package to contain the potatoes and melted disk, it is to be understood that the cooked potatoes and melted disk with seasoning 16 can be removed from the package 12 prior to complete mashing and after possible tossing of the cooked potatoes 11 and melted disk 15 while still in the package to assist in further distribution of the disk components onto the potatoes. The mashed potatoes, or partially mashed potatoes, can then be removed from the package and additionally mashed externally, for example, on a plate, pan or mat, such as a silicone pad. The final mashed texture can be chosen by the consumer and refined as desired. Additional mashing to a finer texture can be accomplished with an implement, such as a fork, by each individual consumer, for example, while on their plate. Weight loss by mashing internally and internally/externally of the package as described results in about the same loss of product weight, about 3-4 grams with a product starting weight of a pound. Such weight loss includes loss of water, as well as potato solids and fat.

In the potato business, potatoes command a price by several factors. Variety, visual quality and importantly, size. To the consumer, size is often ignored. Small potatoes, designated creamers by the FDA, i.e., less than 1⅝″ in diameter (as defined by the FDA), command premium pricing. Large potatoes, as designated by the FDA, i.e. larger than 3″ in diameter, also command a premium price. Potatoes sized between these sizes, for example, grade B as designated by the FDA, find very low consumer appeal and use, and thus are low in price to encourage sales. The present invention is able to effectively use these potatoes to make a value-added product, do not require peeling or other undesirable or tedious processing steps, and have been found to provide a peeling weight to flesh weight that is desirable for consumers. Additionally, with the present invention, the whole potato is used without undesirable consumer processing steps; and the nutrients in the peel and adjacent the peel which are lost from peeling the potatoes, are also retained and not wasted. The peel contains a significant portion of the potato's total fiber. The present invention allows for an adjustment of the weight of peel to weight of flesh, and hence the percent of fiber in the cooked product for consumption to be easily adjusted.

The potatoes are cooked by microwave energy to produce a mashable texture. It has been found that about 7 minutes in a 1300 watt output oven (as rated by the manufacturer) is adequate when using all grade B potatoes. Cook time can vary by potato size and consumer preference. It is desired to gelatinize a majority of the starch in the potatoes during cooking as indicated by loss of birefringence under polarized light. It has been found that when the starchy part of the potato, i.e., the internal flesh, reaches a temperature of at least about 90° C., the potato can be readily mashed and the peel readily torn adequately for mixing with the starchy potato interior.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary, and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A shelf stable packaged food product for heating in a microwave oven, the food product comprising:
a substantially closed package with a storage chamber, said package being vented to relieve pressure in the chamber during microwave heating;
a plurality of fresh potatoes in said package storage chamber with said potatoes including whole unpeeled potatoes sized to provide about 4 to 35 potatoes per pound of potatoes; and
indicia on said package providing information on heating said potatoes in said package in a microwave oven and thereafter mashing the heated potatoes to thereby form mashed potatoes.

2. The food product of claim 1 including at least one fat containing disk in solid form when at 80° F. and having a weight of about 10 grams to about 30 grams per pound of potatoes in the package, said disk containing a fat component, at least a portion of which is milkfat, said fat component containing less than about 1% water by weight of fat plus water and at least one seasoning in particulate form mixed in said fat component, said disk being contained in said package with said potatoes, said disk being contained in said package in a manner that said fat component of said disk will come into contact with said potatoes during heating of said potatoes for consumption.

3. The food product of claim 2 wherein said indicia including information regarding mashing said potatoes in said package after heating.

4. The food product of claim 3 wherein said disk is positioned on top of said potatoes and in contact therewith during storage.

5. The food product of claim 3 wherein said fat component is at least about 99% by weight fat.

6. The food product of claim 3 wherein said disk has a water activity of less than about 0.5.

7. The food product of claim 5 wherein said fat component includes at least about 50% by weight milkfat.

8. The food product of claim 7 wherein said fat includes at least about 95% by weight milkfat.

9. The food product of claim 8 wherein the at least one disk contains seasoning in an amount in the range of between about 25:75 percent by weight and about 75:25 percent by weight of seasoning to said fat component.

10. The food product of claim 3 wherein said disk is positioned in a packet in said package, separating said disk from said potatoes.

11. A method of cooking potatoes, the method comprising:
providing a plurality of fresh whole unpeeled potatoes in a substantially sealed package with a storage chamber, said potatoes being sized to provide about 4 to 35 potatoes per pound of potatoes; and
heating said potatoes in a microwave oven in the substantially sealed package and generating steam and retaining a portion of the generated steam in said storage chamber during said heating, said heating being continued until at least a significant portion of said potatoes have a starch component thereof gelatinized;
terminating said heating in said microwave oven and mashing said potatoes.

12. The method of claim 11 including providing at least one fat containing disk in said package, said at least one disk being in solid form when at 80° F. and having a weight of about 10 grams to about 30 grams per pound of said potatoes, said disk containing a crystalline fat component at least a portion of which is milkfat, said fat component containing less than about 1% water by weight of fat plus water and at least one seasoning in particulate form mixed in said fat component, heating said disk during heating of said potatoes until said at least one disk is melted and said potatoes are heated during said heating of said potatoes in a manner that portions of said fat component will come into contact with said potatoes during heating of said potatoes for consumption.

13. The method of claim 12 including mashing said potatoes in said package and thereafter removing substantial portions of said mashed potatoes and melted disk from the package.

14. The method of claim 13 including removing said potatoes and a substantial portion of the said melted disk from said package and thereafter additionally mashing said potatoes.

15. The method of claim 12 wherein said at least one disk is separated from said potatoes by a barrier that allows said fat component of said at least one disk to contact said potatoes when said barrier is heated during heating of said potatoes.

16. The method of claim 12 wherein said at least one disk is in contact with at least some of said potatoes prior to said heating.
